(19) United States
(12) Patent Application Publication
(10) Pub. No.: US 2019/0248135 A1
(43) Pub. Date: Aug. 15, 2019

(54) COUPLING ELEMENT CORRESPONDING TO IDENTIFIER

(71) Applicant: Hewlett-Packard Development Company, L.P., Spring, TX (US)

(72) Inventor: Leslie Drogo, San Diego, CA (US)

(21) Appl. No.: 16/331,404

(22) PCT Filed: Sep. 9, 2016
(86) PCT No.: PCT/US2016/050917

§ 371 Date: Mar. 7, 2019

(51) Int. Cl. B41J 2/07; B41J 2/175

(52) U.S. Cl. CPC B41J 2/07; B41J 2/175

(57) ABSTRACT

Examples include a coupling element comprising a first member to engage a support member of a fluid ejection apparatus. An example coupling element further comprises a set of connection prongs to couple a control circuit to the support member, where the set of connection prongs are arranged to correspond to an identifier.

### BACKGROUND

A fluid ejection apparatus, such as a printer, a print bar, a multifunction printer, and/or other such devices may be used to print content onto a physical medium (also referred to as media or substrate). In some fluid ejection apparatuses or fluid ejection systems integrating such fluid ejection apparatuses, selective ejection of fluid drops may be performed to print content onto the physical medium.

### DRAWINGS

FIGS. 1A-B provide diagrams of some components of an example fluid ejection apparatus.

FIGS. 2A-B provide diagrams of some components of an example fluid ejection apparatus.

FIGS. 3A-B provides a diagram of some features of an example coupling element.

FIG. 4 provides a block diagram of some components of an example fluid ejection system.

FIG. 5 provides a block diagram of some components of an example fluid ejection system.

FIG. 6 provides a flowchart that illustrates a sequence of operations that may be performed by an example control circuit and/or system.

FIG. 7 provides a flowchart that illustrates a sequence of operations that may be performed by an example control engine and/or system.

Throughout the drawings, identical reference numbers designate similar, but not necessarily identical, elements. The figures are not necessarily to scale, and the size of some parts may be exaggerated to more clearly illustrate the example shown. Moreover the drawings provide examples and/or implementations consistent with the description; however, the description is not limited to the examples and/or implementations provided in the drawings.

### DESCRIPTION

Fluid ejection systems and fluid ejection apparatuses thereof may correspond to two-dimensional printing systems, three-dimensional printing systems, and/or such other types of devices in which drops of fluid may be selectively ejected on a substrate. A fluid ejection device, as used herein, may comprise at least one fluid ejection element, where the fluid ejection element may comprise nozzles having orifices through which drops of fluid may be ejected. In some examples, a fluid ejection element may correspond to a printhead.

In example fluid ejection devices, fluid ejectors may be positioned proximate the nozzle orifices to cause ejection of fluid therethrough. To eject a drop of fluid via a respective nozzle orifice, a fluid ejector may be actuated by a control circuit such that the fluid ejector displaces a volume of fluid proximate the respective nozzle orifice. In some examples, a fluid ejector may be a thermal-based fluid ejector, a piezoelectric-based fluid ejector, a magnetostrictive-based fluid ejector, and/or other such types of fluid ejectors. As will be appreciated, by selectively ejecting fluid drops from a plurality of nozzles content may be distributed on a substrate. To control ejection of fluid ejectors of fluid ejection devices, examples described herein may comprise a control circuit connected to at least one fluid ejection device and the fluid ejectors thereof. Some examples may comprise a control circuit connected to more than one fluid ejection device. A control circuit may receive control data from a control engine that corresponds to nozzles to eject drops of fluid and timing of such ejection. Each control circuit of examples described herein may be connected to the control engine of the system by a communication element. Examples of communication elements that may be implemented includes fiber optic cables, twisted pair cables, coaxial cables, direct copper cables, and/or other such types of communication elements over which data may be transmitted.

In some fluid ejection systems and apparatuses, fluid ejection devices may be arranged generally end-to-end along a width of a fluid ejection apparatus, where the width of the fluid ejection apparatus may correspond to a dimension of the substrate onto which fluid is to be ejected. For example, a fluid ejection system may correspond to a high-speed printing system that may print content on a substrate having a width. In some examples, a system may comprise at least one fluid ejection apparatus that may be referred to as a print bar. Fluid ejection devices may be arranged generally end-to-end along a width of the fluid ejection apparatus such that content may be formed along the width of the substrate concurrently. In some examples, printing of content across the width of the substrate may be referred to as page-wide printing. In some examples, the fluid ejection system may correspond to a three-dimensional printing system. In this example, fluid ejection devices may be arranged along a width of a fluid ejection apparatus, where the width of the fluid ejection apparatus may correspond to at least one dimension of a build area of the three-dimensional printing system.

As will be appreciated, in such examples, each fluid ejection device may correspond to a particular portion of the width of the substrate onto which fluid is to be distributed. For example, a fluid ejection apparatus may comprise four fluid ejection devices arranged along a width of the fluid ejection apparatus. In this example, a first fluid ejection device may correspond to a first portion of the substrate width, and the first fluid ejection device may be positioned on a support member of the fluid ejection device at a first location. A second fluid ejection device may correspond to a second portion of the substrate width, and the second fluid ejection device may be positioned on the support member at a second location. A third fluid ejection device may correspond to a third portion of the substrate width, and the third fluid ejection device may be positioned on the support member at a third location. A fourth fluid ejection device may correspond to a fourth portion of the substrate width, and the fourth fluid ejection device may be positioned on the support member at a fourth location.

Furthering the example, the first fluid ejection device may be controlled by a first control circuit; the second fluid ejection device may be controlled by a second control circuit; the third fluid ejection device may be controlled by a third control circuit; and the fourth fluid ejection device may be controlled by a fourth control circuit. Continuing the example, each control circuit may be connected to the control engine with a respective communication element. In such examples, a particular communication port of the control engine may correspond to a particular control circuit associated with a particular portion of the substrate. For example, a first communication port of the control engine may connected to the first control circuit which corresponds to the first portion of the substrate.

In the example, to print content on the substrate, the control engine may transmit control data associated with a respective portion of the substrate to a respective control circuit that controls the respective corresponding fluid ejection device, e.g., the control engine may transmit control data associated with the first portion of the substrate to the first control circuit. However, it will be appreciated that if a connection element is connected to an incorrect control circuit, the control engine may transmit incorrect control data to the incorrect control circuit, which in turn may cause incorrect fluid ejection. For example, if a particular communication element connects a communication port of the control engine corresponding to the first portion of the substrate with the second control circuit, the second fluid ejection device may eject fluid drops to form content on the second portion of the substrate that should have been formed on the first portion of the substrate.

In example systems, connection elements may appear similar, and routing of such connection elements may lead to further difficulties in connecting the correct communication port of the control engine with the correct control circuit. Accordingly, examples provided herein may comprise a coupling element to couple a support member of a fluid ejection apparatus with a control circuit of the fluid ejection apparatus. An example control circuit may comprise a set of connection terminals, and an example coupling element may comprise a set of connection prongs, where the set of connection prongs may be arranged such that a subset of the connection terminals of the control circuit may be engaged by the connection prongs. The arrangement of the connection prongs, and therefore the connection terminals engaged thereby, may correspond to an identifier. In such examples, the identifier may further correspond to a location along the width of the fluid ejection apparatus. Accordingly, the control circuit may determine the identifier based on the subset of connection terminals. The identifier may be transmitted via the communication element to the control engine. The control engine may determine, based on the identifier, whether the communication element is connected to the correct control circuit.

As used herein, it will be appreciated that an example control circuit comprises at least one processing resource. A processing resource may comprise a central processing unit (CPU), a graphics processing unit (GPU), an application-specific integrated circuit (ASIC), a controller, and/or other such configurations of logical components for data processing. In examples included herein, a control circuit may further comprise at least one memory resource. A memory resource, as used herein, may comprise volatile and/or non-volatile memory as well as other types of memory (e.g. cache memories, memory registers, memory buffers, read-only memories, mass-storage resources, etc.). In examples described herein, control data corresponding actuation of fluid ejectors of a fluid device connected to a control circuit may be stored in a memory resource of the control circuit, and a processing resource of the control circuit may control fluid ejectors of the fluid ejection device based on the control data to thereby eject fluid drops.

Furthermore, as discussed example fluid ejection systems, may comprise engines, which may be referred to as a control engine or a print engine. Such engines may be any combination of hardware and programming to implement the functionalities of the respective engines. In some examples described herein, the combinations of hardware and programming may be implemented in a number of different ways. For example, the programming for the engines may be processor executable instructions stored on a non-transitory machine-readable storage medium and the hardware for the engines may include a processing resource to process and execute those instructions.

In some examples, a fluid ejection system implementing such engines may include the machine-readable storage medium storing the instructions and the processing resource to process the instructions, or the machine-readable storage medium may be separately stored and accessible by the system and the processing resource. In some examples, engines may be implemented in circuitry. Moreover, processing resources used to implement engines may comprise at least one central processing unit (CPU), a filed programmable gate array (FPGA) device, a complex programmable logic device (CPLD), a graphics processing unit (GPU), an application specific integrated circuit (ASIC), a specialized controller (e.g., a memory controller) and/or other such types of logical components that may be implemented for data processing.

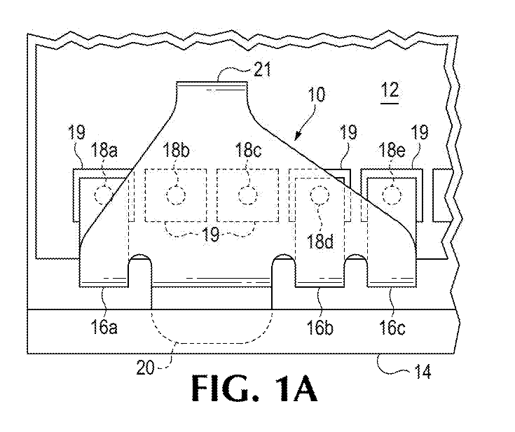

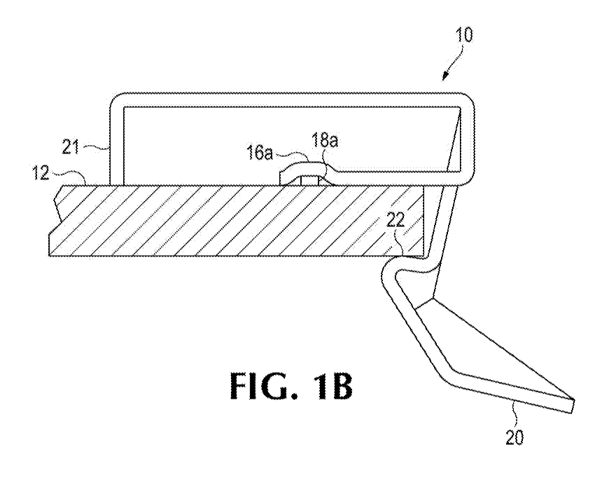

Turning now to the figures, and particularly to FIGS. 1A-B, these figures provide diagrams of an example coupling element 10. In FIG. 1A, a control circuit 12 and support member 14 (provided in dashed line) are illustrated for reference. The example coupling element 10 comprises a set of connection prongs 16a-c. While, in this example, the coupling element 10 comprises three connection prongs 16a-c, it will be appreciated that other examples may comprise more than three connection prongs or less that three connection prongs. Moreover, it will be appreciated that the arrangement of the connection prongs 16a-c are one example of an arrangement, and other arrangements may be implemented in other examples.

In FIG. 1A the control circuit 12 comprises a set of connection terminals 18a-e. In this example, the control circuit 12 comprises an electrical insulation pad 19 surrounding each connection terminal 18a-e. As shown, the set of connection prongs 16a-c of the coupling element 10 engage a subset of the connection terminals 18a, 18d, 18e. As used herein, it will be appreciated that engagement of a connection prong and a connection terminal may include adjacent positioning thereof such that the connection prong and connection terminal may be electrically connected. In some examples, such engagement may comprise surface-to-surface contact.

In the example of FIG. 1A, it will be appreciated that the connection prongs 16a-c do not engage all of the connection terminals 18a-e. In particular, a second connection terminal 18b and a third connection terminal 18c of the control circuit are not engaged by the connection prongs 16a-c of the coupling element 10. In other examples, it will be appreciated that more or less connection terminals may be implemented on example control circuits and more or less connection prongs may engage such connection terminals. In the example of FIG. 1A, the arrangement of connection prongs 16a-c may correspond to a particular identifier. In examples similar to the example of FIG. 1A, when the coupling element 10 is coupled to the control circuit, the control circuit may determine the particular identifier based on which of the set of connection terminals 18a-e are engaged by connection prongs 16a-c of the coupling element 10.

In some examples, the coupling element 10 may comprise a first member 20 that may engage the support member 14. The first member 20 may be removably coupled to the support member 14 such that the control circuit 12 is thereby coupled to the support member 14. In some example fluid ejection systems, the support member 14 may be electrically grounded. Accordingly, when coupled to the support member 14, the coupling element 10 may be electrically grounded. In turn, the connection terminals 18a, 18d, 18e engaged with the connection prongs 16a, 16b, 16c may be electrically grounded. As will be appreciated, in some examples, a control circuit may determine the identifier corresponding to the coupling element based at least in part on the connection terminals that are electrically grounded. FIG. 1B illustrates a side view of the example coupling element 10. As shown, the connection prong 16a of the coupling element 10 may engage a connection terminal 18a of the control circuit 12. Furthermore, the coupling element 10 may comprise a support tab 21 formed on a portion of the coupling element to contact the control circuit formed on a portion of the coupling element to rest on a surface of the control circuit 12 spaced apart from the connection terminals 18a. The coupling element 10 may further engage a bottom surface of the control circuit 12 at a location 22 spaced apart from the connection terminals 18a-e to facilitate physically coupling of the control circuit 12 and the support member 14.

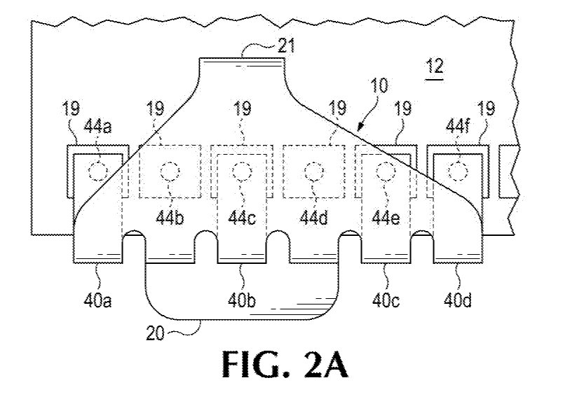

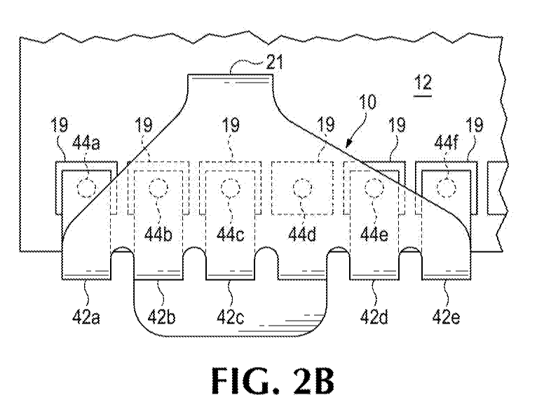

FIGS. 2A and 2B provide diagrams of an example coupling element 10 having different arrangements of connection prongs. In FIGS. 2A-B, the coupling element 10 includes respective sets of connection prongs 40a-d, 42a-d arranged such that the connection prongs 40a-d engage a subset of connection terminals 44a-f of the control circuit 12. In FIG. 2A, the connection prongs 40a-d engage a first connection terminal 44a, a third connection terminal 44c, a fifth connection terminal 44e, and a sixth connection terminal 44f. In FIG. 2B, the connection prongs 42a-e engage the first connection terminal 44a, a second connection terminal 44b, the third connection terminal 44c, the fifth connection terminal 44e, and a sixth connection terminal 44f.

In the example, it will be appreciated that the arrangement of the connection prongs 40a-d in FIG. 2A may correspond to a first identifier, and the arrangement of the connection prongs 42a-e in FIG. 2B may correspond to a second identifier, where the first and second identifier are different. Accordingly, the coupling element 10 of FIG. 2A and the coupling element of FIG. 2B may be implemented such that the respective identifier may be determined by the control circuit 12 based on the connection terminals 44a-f engaged by the connection prongs 40a-d, 42a-e. As will be appreciated, based on the respective identifier of the respective coupling element, an example control engine may determine whether a respective communication element is correctly connected between the control engine and a respective control circuit.

Furthermore, while examples illustrated in FIGS. 1A-2B illustrate various arrangements and numbers of connection prongs, it will be appreciated that other arrangements and other numbers of connection prongs may be implemented in other examples. For example, some example coupling elements may comprise three or more connection prongs. Furthermore, it will be appreciated that the arrangement and number of connection terminals of a control circuit may differ in other examples.

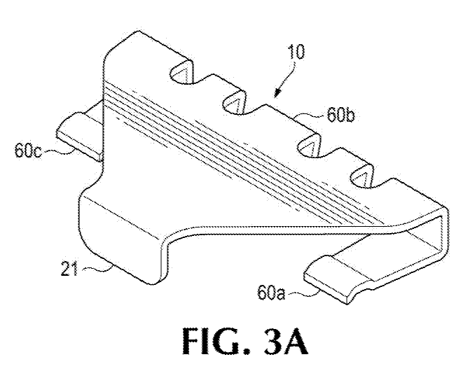

FIGS. 3A-B provide perspective views of an example coupling element 10. As shown in FIG. 3A, the coupling element 10 may comprise a first connection prong 60a, a second connection prong 60b, and a third connection prong 60c. As discussed previously, the arrangement and number of the connection prongs 60a-c may correspond to an identifier. As used herein, the arrangement of connection prongs corresponds to the spacing between neighboring connection prongs, a width of connection prongs, a length of connection prongs, and/or other such dimensions that may facilitate varied engagement with various arrangements of connection terminals. As will be appreciated, the arrangement between connection prongs of a set correspond to at least some connection terminals of a control circuit. As shown in FIG. 3B, the first member 20 (which may be referred to as a securing member) may comprise a structure 64, where the structure may engage a corresponding notched surface of a support member of a fluid ejection apparatus when coupled thereto.

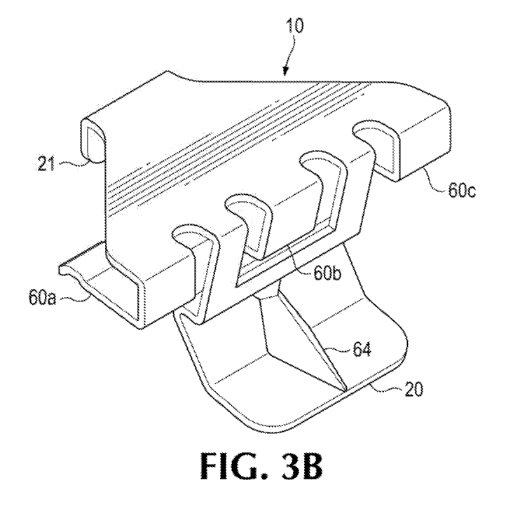

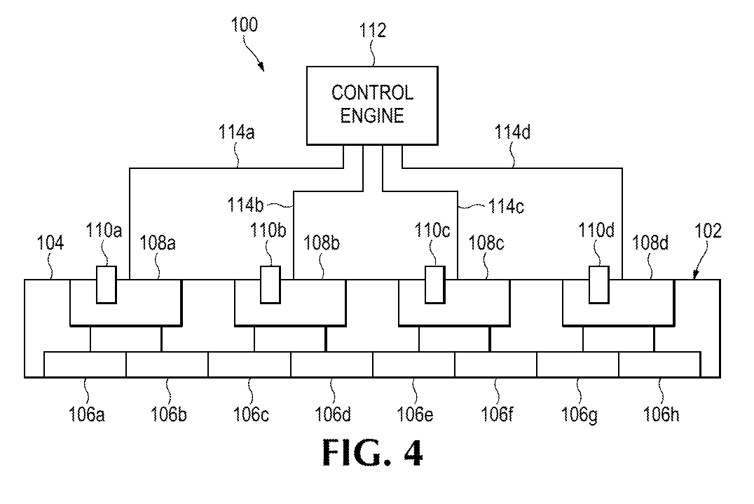

Turning now to FIG. 4, this figure illustrates a block diagram of an example fluid ejection system 100. In this example, the system 100 comprises a fluid ejection apparatus 102 that includes a support member 104, fluid ejection devices 106a-h, control circuits 108a-d, and coupling elements 110a-d. Furthermore, the system 100 comprises a control engine 112. As discussed previously, the control engine may comprise any combination of programming and hardware to perform operations described herein. In particular, the control engine may receive data corresponding to operation of the fluid ejection devices 106a-h. In some examples, such data may be referred to as print data. The control engine may generate control data for each fluid ejection device 106a-h based on the received operation data for the system. The control engine may transmit the control data for each fluid ejection device 106a-h to control circuits 108a-d via communication elements 114a-d.

Each of the coupling elements 110a-d, as described in previous examples, comprise a respective set of connection prongs, where the arrangement and number of the connection prongs corresponds to a respective identifier. For example, a first coupling element 110a may comprise a set of connection prongs that correspond to a first identifier. In the example illustrated in FIG. 4, each control circuit 108a-d is connected to two respective fluid ejection devices 106a-h. It will be appreciated that in other examples, a control circuit may be connected to more or less fluid ejection devices. As shown, the fluid ejection devices 106a-h are generally arranged along a width of the support member 104.

As discussed previously, a position of each fluid ejection device 106a on the support member corresponds to a portion of a substrate for which the fluid ejection device is to form content. Therefore, the control engine 112 receives ejection data that corresponds to fluid to be ejected by the fluid ejection devices 106a-h. The control engine 112 may communicate control data to each control circuit 108a-d that corresponds to the fluid ejection devices 106a-h that the control circuit 108a-d is to control. In this example, a first control circuit 108a is to control a first fluid ejection device 106a and a second fluid ejection device 106b. A second control circuit 108b is to control a third fluid ejection device 106c and a fourth fluid ejection device 106d. A third control circuit 108c is to control a fifth fluid ejection device 106e and a sixth fluid ejection device 106f. A fourth control circuit 108d is to control a seventh fluid ejection device 106g and an eight fluid ejection device 106h. While not shown, it will be appreciated that each fluid ejection device 106a-h comprises at least one fluid ejection element having nozzles and fluid ejectors.

In the example, the control engine 112 may communicate control data to: the first circuit 108a for the first and second fluid ejection devices 106a-b via a first communication element 114; the second control circuit 108b for the third and fourth fluid ejection devices 106c-d via a second communication element 114b; the third control circuit 108c for the fifth and sixth fluid ejection devices 106e-f via the third communication element 114c; and the fourth control circuit 108d for the seventh and eight fluid ejection devices 106g-h via the fourth communication element 114d.

In examples similar to the example system 100 of FIG. 4, each respective control circuit 108a-d may determine the respective identifier corresponding to the arrangement of the respective coupling element 110a-d that couples the respective control circuit 108a-d to the support member 104. For example, the first control circuit 108a may determine a first identifier that corresponds to the arrangement of connection prongs of the first coupling element 110a. Each respective control circuit 108a-d may communicate the determined respective identifier to the control engine 112 via the respective communication element 114a-d. The control circuit may determine, based on the respective identifier received via each respective communication element 114a-d whether the each respective communication element 114a-d is connected to the correct (i.e., expected) control circuit 108a-d.

As will be appreciated, the respective identifier of each coupling element 108a-d may correspond to a respective location of the respective fluid ejection devices 106a-h and respective control circuit 108a-d on the support member 104. In turn, the respective location of the respective fluid ejection devices 106a-h and the respective control circuit 108a-d corresponds to a respective portion of a substrate for which the respective fluid ejection devices 106a-h are to eject fluid. For example, the first identifier corresponding to the arrangement of the connection prongs of the first coupling element 110a corresponds to the location of the first and second fluid ejection devices 106a-b on the support member. Therefore, the control engine 112 may determine whether the first communication element 114a is connected to the first control circuit 108a based on the identifier determined from the first coupling element 110a.

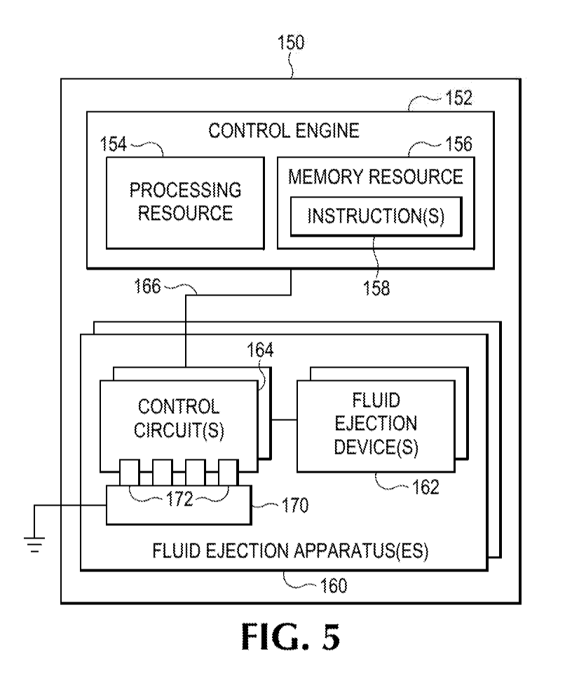

FIG. 5 provides a block diagram that illustrates some components of an example fluid ejection system 150. In this example, the system 150 includes a control engine 152. In this example, the control engine is illustrated as comprising a processing resource 154 and a memory resource 156. As described previously, the processing resource 154 may comprise at least one hardware based processor, such as a controller, central processing unit, or other such arrangements of data processing logic. Furthermore, as described above, the memory resource 156 may comprise at least one memory device, such as a random access memory module, at least one memory buffer, and/or other such memory devices. The memory resource 156 may store instructions 158 that are executable by the processing resource 154. Execution of the instructions 158 may cause the processing resource 154 and/or system 150 to perform the functionalities, processes, and/or sequences of operations described herein.

As shown, the system 150 comprises a plurality of fluid ejection apparatuses 160. Each fluid ejection apparatus 160 may comprise a plurality of fluid ejection devices 162. As discussed with regard to other examples, the fluid ejection devices 162 may be arranged generally end-to-end along a support member of the fluid ejection apparatus 160. In addition, each fluid ejection apparatus 160 comprises a plurality of control circuits 164, where each control circuit 164 is connected to at least one fluid ejection device 162. In turn, each control circuit 164 is connected to the control engine 152 via a respective communication element 166. In some examples, each fluid ejection apparatus 160 comprises at least four control circuits 164, and at least two fluid ejection devices 162 for each control circuit 164. Furthermore, in some examples, the system 150 comprises at least four fluid ejection apparatuses 160, each fluid ejection apparatus 160 comprises at least four control circuits 164, and each fluid ejection apparatus 160 comprises at least two fluid ejection devices 162 for each control circuit 164. As will be appreciated, the system 150 may comprise a respective communication element 166 for each control circuit 164.

In this example, for each respective control circuit 164, a respective fluid ejection apparatus 160 comprises a respective coupling element 170 that may couple the respective control circuit 164 to the support member of the fluid ejection apparatus 160. Each respective control circuit 164 comprises a set of connection terminals (not shown), and the respective coupling element 170 comprises a set of connection prongs 172. The set of connection prongs 172 correspond to at least a subset of the set of connection terminals of the control circuit 164.

Furthermore, the arrangement of the set of connection prongs 172 of a coupling element 170 correspond to an identifier, such that each coupling element for a fluid ejection apparatus 160 has a different arrangement of connection prongs 172 and therefore corresponds to a different identifier. As described previously, the connection prongs 172 of a coupling element 170 may engage the subset of the connection terminals of the respective control circuit. Based on the connection terminals engaged by the connection prongs 172 of a respective coupling element, a respective control circuit may determine the corresponding identifier. As shown in this example, each coupling element 170 may be electrically grounded such that the connection terminals engaged by connection prongs of a coupling element may be electrically grounded.

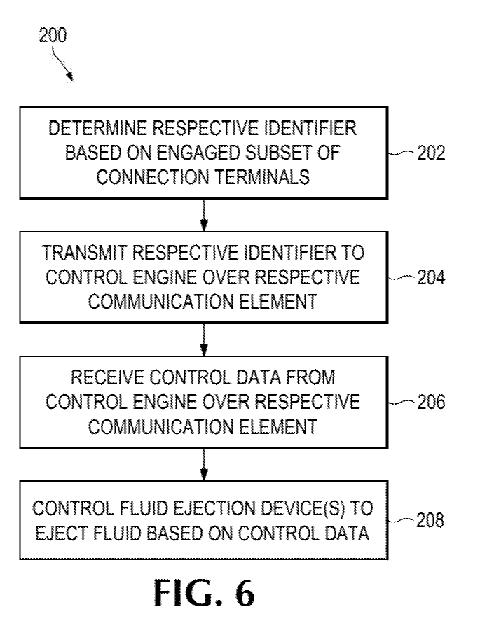

FIGS. 5-6 provide flowcharts that provide example sequences of operations that may be performed by an example system, engine, and/or a control circuit thereof to perform example processes and methods as described herein. In some examples, some operations included in the flowcharts may be embodied in a memory (such as the memory resource 156 of FIG. 5) in the form of instructions that may be executable by a processing resource to cause an apparatus and/or controller to perform the operations corresponding to the instructions. Additionally, the examples provided in FIGS. 5-6 may be embodied in computing devices, machine-readable storage mediums, processes, and/or methods. In some examples, the example processes and/or methods disclosed in the flowcharts of FIGS. 5-6 may be performed by a controller and/or engine implemented in a system.

FIG. 5 is a flowchart 200 that illustrates an example sequence of operations that may be performed by an example control circuit. The control circuit may determine a respective identifier corresponding to a coupling element engaged with the control circuit based at least in part on a subset of connection terminals engaged by connection prongs of the coupling element (block 202). The control circuit transmits the respective identifier to a control engine over a respective communication element connected therebetween (block 204). After communication of the respective identifier, the control circuit may receive control data from the control engine over the communication element (block 206), and the control circuit may control ejection of fluid for at least one fluid ejection device based at least in part on the control data (block 208).

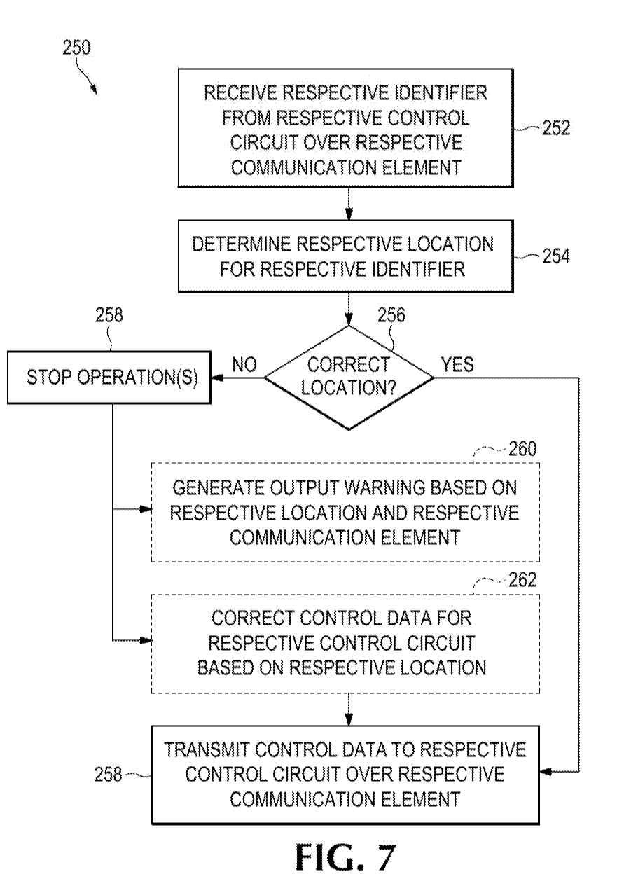

FIG. 7 is a flowchart 250 that illustrates a sequence of operations that may be performed by an example control engine in a fluid ejection system comprising a plurality of control circuits coupled to a support member of a fluid ejection apparatus via coupling elements having connection prongs arranged to correspond to respective identifiers. The control engine may receive a respective identifier from a respective control circuit via a respective communication element (block 252). The control engine may determine a respective location associated with the respective identifier (block 254). As discussed previously, a respective identifier of a coupling element may correspond to a location of the support member at which the control circuit is coupled. The location of support member at which the control circuit is coupled further corresponds to a portion of a substrate for which the control circuit is to control fluid ejection to form content.

The control engine determines whether the respective location corresponds to the correct location for the respective communication element and respective control circuit (block 256). As will be appreciated, by receiving the respective identifier over the respective communication element, the control engine may determine whether the respective communication element is connected to the correct (e.g., expected) control circuit such that control data communicated via the respective communication element is to be communicated to the correct control circuit. As will be appreciated, in some examples, the control engine may store information that indicates an expected identifier for each communication element, where, as discussed, the expected identifier corresponds to an expected location on the support member and portion of a substrate. Therefore, in these examples, determining whether the respective location is correct for the respective communication element may comprise comparing the received identifier and/or the determined location to the expected location and/or expected identifier to determine whether the communication element is connected to the correct control circuit in the fluid ejection system.

In response to determining that the respective location is the correct location (“Y” branch of block 256), the control engine may transmit control data to the respective control circuit over the respective communication element (block 258). In response to determining that the respective location is not the correct location (“N” branch of block 256), the control engine may stop at least one operation of the fluid ejection system (block 260). For example, if the respective location determined for the respective control circuit is a first location, but the expected location is a second location, the control engine may stop operations such that fluid ejection does not occur.

In some examples, in response to determining that the respective location is not the correct location (“N” branch of block 256), the control engine may further generate an output warning based on the respective location and the respective communication element (block 260). As will be appreciated, the fluid ejection system may comprise at least one output device, such as a display, a touchscreen, a plurality of indicators, and/or other such output devices (e.g., a speaker, etc.). In such examples, the control engine may cause such output device to indicate that the respective communication element is incorrectly connected.

In some examples, in response to determining that the respective location is not the correct location (“N” branch of block 256), the control engine may correct control data for the respective control circuit based on the respective location (block 262). For example, a first control circuit may be expected to correspond to a first location associated with a first portion of the substrate, and a second control circuit may be expected to correspond to a second location associated with a second portion of the substrate. The first control circuit may be connected to the control engine via a first communication element, and the second control circuit may be connected to the control engine via a second communication element. The first control circuit may be coupled to a support member of the fluid ejection apparatus via a first coupling element, and the second control circuit may be coupled to the support member via a second coupling element. The first coupling element may comprise a first arrangement of connection prongs that correspond to a first identifier, and the second coupling element may comprise a second arrangement of connection prongs that correspond to a second identifier.

In this example, the control engine may receive the first identifier corresponding to the first coupling element from the first control circuit via the first communication element. If the first identifier corresponds to the second location, the control engine may determine that the respective location for the first control circuit and the first communication element is not correct—i.e., the first communication element is not connected to the expected control circuit. While in some examples, the control circuit may stop operations and generate an output warning, in other examples, the control circuit may determine the correct control data to be transmitted over the first communication element. In this example, the control data corresponding to the second portion of the substrate would be transmitted over the first communication element due to detection of the unexpected (i.e., incorrect) connection. Therefore, as described herein, the control engine may correct control data prior to transmission of the control data over a communication element when the control engine determines that the communication element is not connected to the expected control circuit.

Therefore, example apparatuses and processes described herein include coupling elements comprising connection prongs that correspond to connection terminals of control circuits. The connection prongs of a respective coupling element may be arranged to correspond to a respective identifier, where the arrangement of the connection prongs may facilitate engagement with at least some connection terminals of the control circuit. Based on the arrangement of the connection prongs and engagement with the connection terminals thereof, a control circuit may determine the respective identifier, where the respective identifier may be used to determine correct connection of communication elements in a fluid ejection system.

While various examples are described herein, elements and/or combinations of elements may be combined and/or removed for various examples contemplated hereby. For example, the example operations provided herein in the flowcharts of FIGS. 5-6 may be performed sequentially, concurrently, or in a different order. Moreover, some example operations of the flowcharts may be added to other flowcharts, and/or some example operations may be removed from flowcharts. Moreover, some operations of the flowcharts of FIGS. 5-6 may be implemented via control of a controller of various components of an apparatus. Furthermore, in some examples, various components of the examples of FIGS. 1A-5 may be removed, and/or other components may be added. Similarly, in some examples various instructions stored in memory resources, and/or machine-readable storage mediums may correspond to the example operations of FIGS. 5-6.

The preceding description has been presented to illustrate and describe examples of the principles described. This description is not intended to be exhaustive or to limit these principles to any precise form disclosed. Many modifications and variations are possible in light of the above disclosure.

1. A fluid ejection apparatus comprising:
a support member;
a plurality of fluid ejection devices arranged along a length of the support member to selectively eject fluid;
at least one control circuit to control ejection of fluid by the fluid ejection devices, the at least one control circuit including a set of connection terminals; and
at least one coupling element to removably couple the at least one control circuit to the support member, the at least one coupling element comprising a set of connection prongs arranged to engage a subset of connection terminals of the set of connection terminals of the at least one control circuit, the set of connection prongs arranged to correspond to correspond to a respective identifier.

2. The fluid ejection apparatus of claim 1, wherein the control circuit is further to:
determine the respective identifier based at least in part on the subset of connection terminals engaged by the set of connection prongs.

3. The fluid ejection apparatus of claim 2, wherein the at least one control circuit is further to control ejection of fluid by the fluid ejection devices based at least in part on ejection data received from a control engine, and the at least one control circuit is further to:
transmit the respective identifier to the control engine prior to controlling the fluid ejection devices to eject fluid.

4. The fluid ejection apparatus of claim 2, wherein the at least one coupling element is electrically grounded, and the control circuit determines the respective identifier based at least in part on the subset of connection terminals electrically grounded by the set of connection prongs.

5. The fluid ejection apparatus of claim 1, wherein the at least one control circuit comprises a plurality of respective control circuits, the at least one coupling element comprises a respective coupling element for each respective control circuit of the plurality, and the set of connection prongs for each respective coupling element correspond to the respective identifier of a plurality of respective identifiers.

6. A coupling element comprising:
a first member to engage a support member of a fluid ejection apparatus;
a set of connection prongs to couple a control circuit to the support member, the set of connection prongs arranged to correspond to an identifier.

7. The coupling element of claim 6, wherein the coupling element comprises a conductive material such that the coupling element is to electrically connect the support member to the control circuit.

8. The coupling element of claim 6, wherein the set of connection prongs are arranged to engage and electrically couple with a subset of connection terminals of a plurality of connection terminals of the control circuit.

9. The coupling element of claim 6, wherein the set of connection prongs comprises at least three connection prongs, and the set of connection prongs are arranged to engage and electrically couple with a corresponding number of connection terminals of a plurality of connection terminals of the control circuit.

10. A system comprising:
a first fluid ejection apparatus the fluid ejection apparatus comprising:
a support member;
a first control circuit and a second control circuit that each include a respective set of connection terminals;
a first coupling element to removably couple the first control circuit to the support member, the first coupling element comprising a first set of connection prongs arranged to engage a first subset of connection terminals of the respective set of connection terminals of the first control circuit, the first set of connection prongs arranged to correspond to a first identifier; and
a second coupling element to removably couple the second control circuit to the support member, the second coupling element comprising a second set of connection prongs arranged to engage a second subset of the respective set of connection terminals of the second control circuit, the second set of connection prongs arranged to correspond to a second identifier.

11. The system of claim 10, wherein the first control circuit is to determine the first identifier based at least in part on the first subset of the connection terminals, and the second control circuit is to determine the second identifier based at least in part on the second subset of the connection terminals.

12. The system of claim 11, wherein the first coupling element and the second coupling element are electrically grounded such that the first subset of connection terminals is electrically grounded when engaged by the first set of connection prongs and such that the second subset of connection terminals is electrically grounded when engaged by the second set of connection prongs, and
wherein the first control circuit to determine the first identifier comprises the first control circuit to detect that the first subset of connection terminals is electrically grounded, and the second control circuit to determine the second identifier comprises the second control circuit to detect that the second subset of connection terminals is electrically grounded.

13. The system of claim 11, further comprising:
a control engine;
a first communication element connecting the control engine to the first control circuit; and
a second communication element connecting the control engine to the second control circuit,
wherein the control engine is to determine a first location for the first communication element based on the first identifier, and the control engine is to determine a second location for the second communication element based on the second identifier.

14. The system of claim 13, wherein the control engine is further to:
determine whether the first location corresponds to a correct location for the first communication element;
determine whether the second location corresponds to a correct location for the second communication element.

15. The system of claim 14, wherein the control engine is further to:
in response to determining that the first location does not correspond to the correct location for the first communication element or the second location does not correspond to the correct location for the second communication element, stop at least one operation of the system.
